(19) United States
(12) Patent Application Publication
(10) Pub. No.: US 2003/0115294 A1
(43) Pub. Date: Jun. 19, 2003

(54) Selective access digital data broadcast system

(76) Inventor: Khoi Hoang, Pleasanton, CA (US)

Correspondence Address: PERKINS COIE LLP, P.O. BOX 2168, MENLO PARK, CA, 94026, US

(21) Appl. No.: 10/291,177

(22) Filed: Nov. 7, 2002

Related U.S. Application Data
(63) Continuation-in-part of application No. 09/584,832, filed on May 31, 2000, now Pat. No. 6,557,030.
(60) Provisional application No. 60/337,539, filed on Nov. 30, 2001.

(51) Int. Cl. G06F 15/16

(52) U.S. Cl. 709/219

(57) ABSTRACT

A client generic uni-directional digital data file download system and method including a method of transmitting non-data-on-demand (non-DOD) data files to a large number of customers comprising the acts of: parsing at least one non-DOD data file into a sequence of data blocks, the sequence being composed of a first plurality of data blocks containing digital data; repeatedly transmitting the sequence of data blocks in a non-client specific manner such that a user receiving the first plurality of data blocks may view at least a portion of the at least one non-DOD data file. Additionally, the present invention includes transmitting an electronic program guide (EPG) to the plurality of users, wherein the user may select a desired data file using the electronic program guide. In accordance with one embodiment each non-DOD data file is allocated an associated bandwidth, wherein the data files are repeatedly transmitted on a corresponding allocated bandwidth.

### CROSS REFERENCE TO RELATED APPLICATIONS

Reference is made and priority claimed to U.S. Provisional Application entitled SELECTIVE ACCESS NON-DOD DIGITAL DATA BROADCAST SYSTEM, filed Nov. 30, 2001 bearing application Ser. No. 60/337,539. This application is a continuation-in-part claiming priority to Khoi Hoang's patent application entitled NON CLIENT SPECIFIC ON-DEMAND DATA BROADCAST (Amended) filed on May 31, 2000, bearing application Ser. No. 09/584,832. This application is related to Khoi Hoang's patent applications entitled A METHOD AND APPARATUS FOR TRANSMITTING NON-VOD SERVICES, filed on Oct. 25, 2001, bearing Attorney Docket Number 60595-301801; SELECTIVE INACTIVATION AND COPY-PROTECTION, filed on Aug. 20, 2001, bearing application Ser. No. 09/933,696, CONTROLLING DATA-ON-DEMAND CLIENT ACCESS, filed on Jul. 9, 2001, bearing application Ser. No. 09/902,503, DECREASED IDLE TIME AND CONSTANT BANDWIDTH DATA-ON-DEMAND BROADCAST DELIVERY MATRICES, filed on Jun. 25, 2001, bearing application Ser. No. 09/892,017, COUNTERFEIT STB PREVENTION THROUGH PROTOCOL SWITCHING, filed on Jun. 25, 2001, bearing application Ser. No. 09/892,015, UNIVERSAL STB ARCHITECTURES AND CONTROL METHODS filed on May 30, 2001, bearing application Ser. No. 09/870,879, METHODS FOR PROVIDING VIDEO-ON-DEMAND SERVICES FOR BROADCASTING SYSTEMS filed Nov. 10, 2000, bearing application Ser. No. 09/709,948 and UNIVERSAL DIGITAL BROADCAST SYSTEM AND METHODS filed on Apr. 24, 2001, bearing application Ser. No. 09/841,792, all eight being incorporated herein by reference.

### BACKGROUND OF THE INVENTION

1. Field of the Invention

The present invention relates to digital information broadcast technology. In particular, the present invention teaches a method and apparatus for broadcasting information services to be selectively stored by clients for access at some future time.

2. Description of the Prior Art

A variety of mechanisms are available for providing digital data services to clients through set top boxes (STB), for display on a television or other video display devices such as computer monitors. One problem faced in such systems is the inability to provide digital programs without using bi-directional communications. Traditional uni-directional communications, such as cable, are capable of providing digital data files such as movies, but users must start receiving such a file at its beginning. Bi-directional communications devices such as computers connected to the internet allowed for digital data programs to be sent to individual clients, however this required significant processing and bandwidth resources and would not work in uni-directional systems. Additionally such bi-directional systems require transmission bandwidth in proportion to the number of clients using the service at any one time.

The following is a general discussion of widely used digital broadcast systems. Generally in digital broadcast systems, a bit stream, multiplexed in accordance with the MPEG-2 standard, is a “transport stream” constructed from “packetized elementary stream” (or PES) packets and packets containing other necessary information. A “packetized elementary stream” (or PES) packet is a data structure used to carry “elementary stream data.” An “elementary stream” is a generic term for one of (a) coded video, (b) coded audio, or (c) other coded bit streams carried in a sequence of PES packets with one stream ID. Transport streams support multiplexing of video and audio compressed streams from one program with a common time base.

PRIOR ART FIG. 1 illustrates the packetizing of compressed video data 106 of a video sequence 102 into a stream of PES packets 108, and then, into a stream of transport stream packets 112. Specifically, a video sequence 102 includes various headers 104 and associated compressed video data 106. The video sequence 102 is parsed into variable length segments, each having an associated PES packet header 110 to form a PES packet stream 108. The PES packet stream 108 is then parsed into segments, each of which is provided with a transport stream header 114 to form a transport stream 112.

PRIOR ART FIG. 2 is a block schematic showing a digital broadcast system 200 including a digital broadcast server 202 and a set-top-box 204 suitable for processing digital broadcast data. At the digital broadcast server 202, video data is provided to a video encoder 206 which encodes the video data in accordance with the MPEG-2 standard. The video encoder 206 provides encoded video 208 to a packetizer 210 which packetizes the encoded video 208. The packetized encoded video 212 provided by the packetizer 210 is then provided to a transport stream multiplexer 214.

Similarly, at the digital broadcast server 202, audio data is provided to an audio encoder 214 which encodes the audio data. The audio encoder 214 provides encoded audio 218 to a packetizer 220 which packetizes the encoded audio 218. The packetized encoded audio 222 provided by the packetizer 220 is then provided to the transport stream multiplexer 214.

The transport stream multiplexer 214 multiplexes the encoded audio and video packets and transmits the resulting multiplexed stream to a set-top-box 204 via distribution infrastructure 224. This distribution infrastructure 224 may be, for example, a telephone network and/or a cable TV (CATV) system, employing optical fiber and implementing asynchronous transfer mode (ATM) transmission protocols. At the set-top-box 204, on a remote end of the distribution infrastructure 224, a transport stream demultiplexer 230 receives the multiplexed transport stream. Based on the packet identification number of a particular packet, the transport stream demultiplexer 230 separates the encoded audio and video packets and provides the video packets to a video decoder 232 via link 238 and the audio packets to an audio decoder 236 via link 240.

The transport stream demultiplexer 230 also provides timing information to a clock control unit 236. The clock control unit 236 provides timing outputs to the both the video decoder 232 and the audio decoder 236 based on the timing information provided by the transport stream demultiplexer 230 (e.g., based on the values of PCR fields). The video decoder 232 provides video data which corresponds to the video data originally provided to the video encoder 206. Similarly, the audio decoder 236 provides audio data which corresponds to the audio data originally provided to the audio encoder 216.

PRIOR ART FIG. 3 shows a simplified functional block diagram of a digital broadcast system 300. At the heart of the digital broadcast system 300 is the video server 310 which routes the digital movies, resident in the movie storage system 312, to the distribution infrastructure 314. This distribution infrastructure 314 may be, for example, a telephone network and/or a cable TV (CATV) system, employing optical fiber and implementing asynchronous transfer mode (ATM) transmission protocols. The distribution infrastructure 314 delivers movies to individual homes based on the routing information supplied by the video server 310.

The digital broadcast system 300 also includes a plurality of STBs 304 suitable for processing digital data broadcast by the digital broadcast system 300. Each STB 304 receives and decodes a digital movie and converts it to a signal for display on a TV set or A/V monitor.

The typical model for digital broadcast systems described above adheres to what is termed a “bi-directional client-server model.” In order to point out defects inherent to this prior art system, the typical hardware architecture generic to such a digital broadcast system will be described below with reference to FIG. 4. Further, methods for controlling the prior art digital broadcast server and the prior art STB will be described below with reference to FIG. 5 and FIG. 6, respectively.

PRIOR ART FIG. 4 illustrates a general diagram of a digital broadcast system 320 having a bi-directional client-server architecture. The digital broadcast system 322 includes a digital broadcast server 322 bi-directionally coupled with a plurality of clients 324 via communication link 326. As will be appreciated, the system 300 of FIG. 3 is a somewhat specific example of the digital broadcast system 320.

Broadly speaking, the digital broadcast system 320 operation adheres to the well known client-server model as follows. In some manner, typically through transmission of an Electronic Program Guide (EPG) by the digital broadcast server 322, the clients 324 are informed of available on-demand data. Using the EPG for reference, a requesting client 324 requests specific data from the digital broadcast server 322 via the communication link 326. The digital broadcast server 322 interprets the client request, and then prepares the client specific data in a format suitable for use by the requesting client 324.

Once the client specific data is prepared, the server 322 transmits the client specific data to the requesting client 324. The requesting client 324 receives, via a specifically allocated portion of the communication link 326, the requested client specific data in a readably usable format. The requested client specific data is provided in a format ready for presentation by the client to the end user. These client-server processes are described below in more detail with reference to FIGS. 5-6.

Under the client-server model of FIG. 4, the available bandwidth of communication link 326 must be divided up into allocated portions 328, each allocated portion being dedicated to a particular client. Hence the bandwidth required for prior art digital broadcast systems is directly proportional to the number of clients being served. Although communication link 326 may be a true bi-directional communications medium, such infrastructure is uncommon. Instead, typical implementations today cobble together existing infrastructure such as fiber optic cabling and telephone lines to implement the necessary bi-directional communications. For example, the fiber optic cable may be used for server transmission of client specific data while an existing telephone line may be used for client transmission of requests.

Turning next to PRIOR ART FIG. 5, a bi-directional digital broadcast server method 340 in accordance with the prior art will now be described. In a first step 342, the digital broadcast server identifies the available slots within the available transmission bandwidth. In a next step 344 the digital broadcast server prepares and transmits a suitable EPG to each client. It will be appreciated that different EPGs may be transmitted for different clients depending upon factors such as subscription levels, available services, personalized settings, payment history, etc. In any event, in a next step 346, the digital broadcast server receives a demand for specific data from a specific client. The demand includes information indicating the identity of the client. Then in a step 348, the digital broadcast server identifies the specific client from information included with the demand.

At a step 350, a determination is made whether the client is authorized to receive the requested data. This determination is made at the digital broadcast server 322 (FIG. 4), where each digital broadcast service has an assigned subscription level requirement. The digital broadcast server compares a client's subscription level stored in the clients data file to the requested service's subscription level requirement. This determination generally requires many complex independent operations, and is described here in only in a very simplified manner.

If the client's subscription level corresponds with the subscription level of the requested data, then the client is authorized to receive the data. If the client is authorized to receive the data requested, the process proceeds to step 351. In step 351, the digital broadcast server assigns an available slot to the authentic client. In step 352, the digital broadcast server prepares the requested client specific data for transmission in a format suitable for the requesting client. Step 348 may include such actions as retrieving the client specific data from a persistent storage mechanism and preparing an appropriate channel server for data transmission. Continuing with a step 354, the digital broadcast server transmits the client specific data via the bandwidth allocated to the requesting client.

If the client is not authorized to receive the requested data, the process proceeds to step 356, where the digital broadcast server transmits a generic message stating that the service is unavailable. Other appropriate data may also be transmitted.

Turning next to FIG. 6, a client method 360 for retrieving on-demand data will now be described. In a tuning step 362, the client will tune into the appropriate channel program and in a receiving step 364 the client will receive the EPG transmitted by the digital broadcast server. In a next step 366, the client provides the EPG information to a user and in a step 368, receives a request for specific data from the user. Then in a step 370, the client demands that the digital broadcast server provide the requested client specific data. In a step 372, in anticipation of the requested client specific data, the client tunes into the allocated bandwidth. Then in a step 374, the client receives via allocated bandwidth the requested client specific data in a readably usable format and provides it to the user.

As the above discussion reflects, none of the prior art systems provide client generic digital data files to a large number of clients over a relatively narrow bandwidth. Therefore, it is desirable to provide a client generic uni-directional digital data file download system and method for downloading digital data for viewing at some future time. It is also desirable to provide a system and method for authorizing such downloads to prevent unauthorized access to digital data files. It would also be desirable to provide a system and method for purchasing the right to download a selected data file in a client generic manner.

### SUMMARY

The present invention teaches a client generic uni-directional digital data file download system and method for downloading digital data for viewing at some future time. The present invention also teaches a system and method for selecting files for download from a “wish list” such that a maximum revenue may be achieved for a broadcast provider. The present invention teaches further teaches a system and method for purchasing the right to download a selected data file in a client generic manner. These include a universal digital data system, an intelligent STB, and a variety of methods for handling these digital services and controlling the intelligent STB.

A first embodiment of the present invention teaches a method of transmitting non-data-on-demand (non-DOD) data files to a large number of customers comprising the acts of: parsing at least one non-DOD data file into a sequence of data blocks, the sequence being composed of a first plurality of data blocks containing digital data; repeatedly transmitting the sequence of data blocks in a non-client specific manner such that a user receiving the first plurality of data blocks may view at least a portion of the at least one non-DOD data file.

The method may further include transmitting an electronic program guide (EPG) to the plurality of users, wherein the user may select a desired data file using the electronic program guide.

A second embodiment teaches a method of downloading non-DOD data files broadcast periodically, using an intelligent STB comprising: receiving a user input indicating at least one selected data file; initiating an authorized download of at least a first part of the selected data file broadcast during the first time interval; retrieving a second part of the data file broadcast during a second time interval; and combining the first part and the second part in order to display at least a portion of the selected data file.

It is important to remark that as types of set-top boxes become more ubiquitous, they are often built-in to a unit, such as a TV or computer, rather than actually set on top or beside. One of ordinary skill in the art would recognize that all references to STBs would apply equally to built-in version, and thus the two become synonymous.

### BRIEF DESCRIPTION OF THE DRAWINGS

PRIOR ART FIG. 1 illustrates pictorially the packetizing of compressed video data into a stream of packets and a stream of transport packets;

PRIOR ART FIG. 2 illustrates by block diagram a system according to the MPEG-2 standard;

PRIOR ART FIG. 3 illustrates a simplified functional block diagram of a digital broadcast system;

PRIOR ART FIG. 4 illustrates a digital broadcast system adhering to a prior art bi-directional client-server architecture;

PRIOR ART FIG. 5 illustrates a digital broadcast server method for controlling the receipt of digital broadcast services by clients using a bi-directional, client specific data transmission mechanism;

PRIOR ART FIG. 6 illustrates a client method for receiving and processing client specific data via a bi-directional transmission mechanism;

FIG. 7 is a block diagram of a digital broadcast server in accordance with one embodiment of the present invention;

FIG. 8 is a block diagram showing the hardware architecture of a intelligent STB in accordance with one embodiment of the present invention;

FIG. 9 is a flow chart diagram illustrating a digital data file transmission process in accordance with one embodiment of the present invention;

FIG. 10 is a flow chart diagram illustrating an intelligent STB process for receiving digital data files in accordance with one embodiment of the present invention;

FIG. 11 shows an exemplary embodiment of a download schedule in accordance with one embodiment of the present invention;

FIG. 12 illustrates an exemplary embodiment of two digital data files being transmitted on two independent bandwidths of a selected physical transmission channel; and

FIG. 13 is a flow chart diagram illustrating an authorized file download process in accordance with one embodiment of the present invention including a bi-directional download authorization process.

### DETAILED DESCRIPTION OF THE PREFERRED EMBODIMENTS

In the following detailed description of the embodiments, reference is made to the drawings that accompany and that are a part of the embodiments. The drawings show, by way of illustration, specific embodiments in which the invention may be practiced. Those embodiments are described in sufficient detail to enable those skilled in the art to practice the invention and it is to be understood that other embodiments may be utilized and that structural, logical, and electrical changes as well as other modifications may be made without departing from the spirit and scope of the present invention.

The present invention teaches a client generic uni-directional digital data file download system and method for downloading digital data for viewing at some future time. The present invention also teaches a system and method for authorizing such downloads to prevent unauthorized access to digital data files. The present invention teaches further teaches a system and method for purchasing the right to download a selected data file in a client generic manner. These include a universal digital data system, an intelligent STB, and a variety of methods for handling these digital services and controlling the intelligent STB. These include a universal digital data system, a intelligent STB, and a variety of methods for handling these digital services and controlling the intelligent STB. However, those skilled in the art will recognize that all aspects of the present invention can be implemented within the bi-directional communication paradigm, the only difference being that even more features can be provided to the and user when a bi-directional communication link is available.

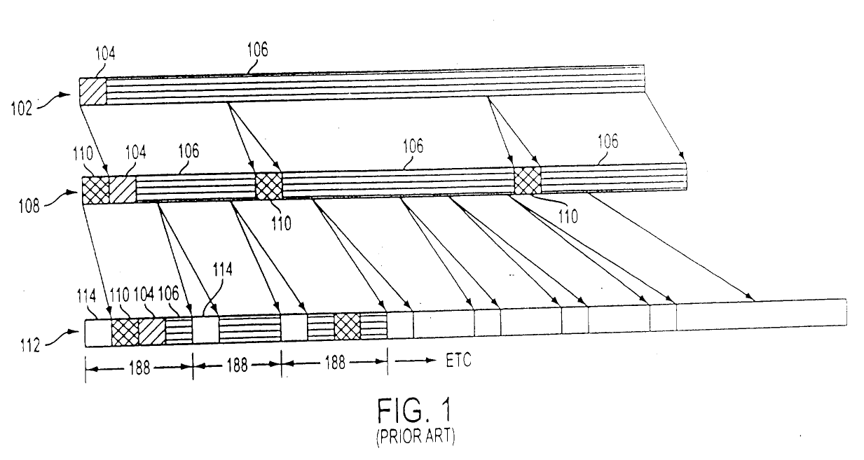

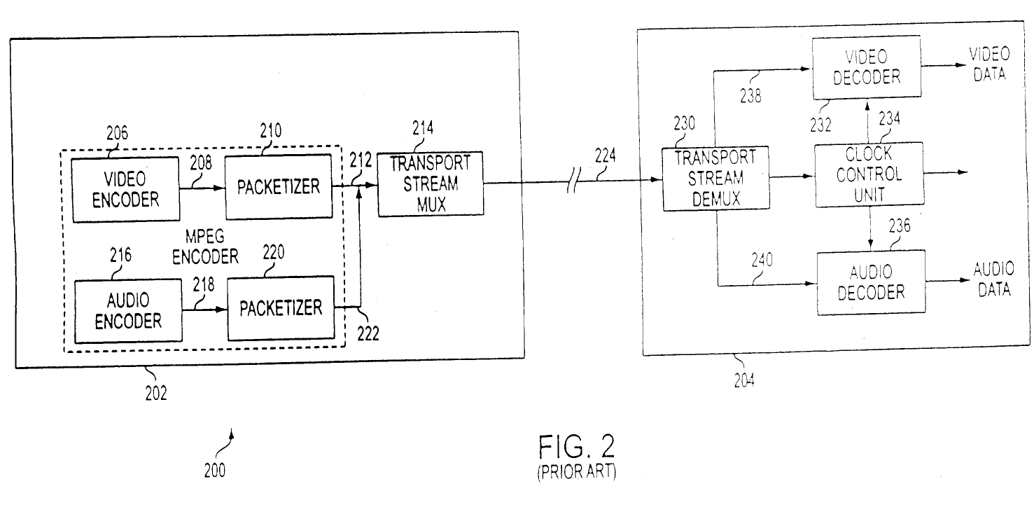

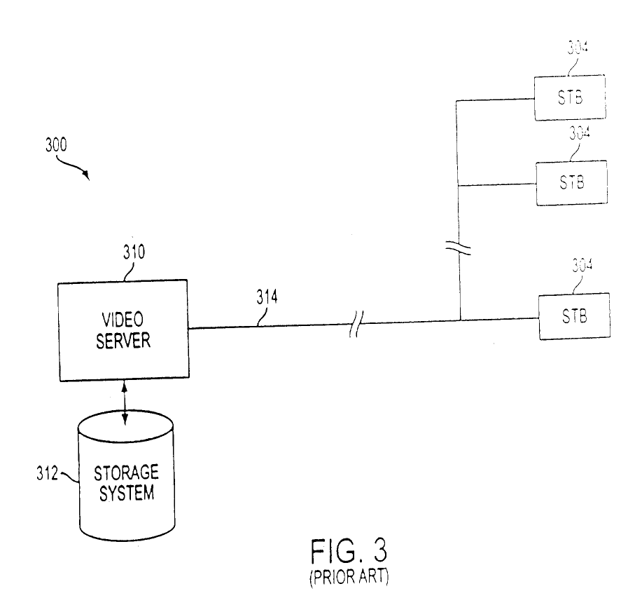

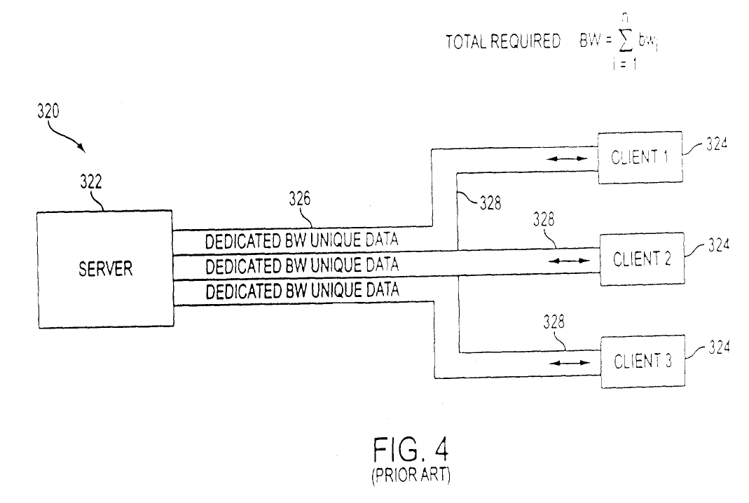

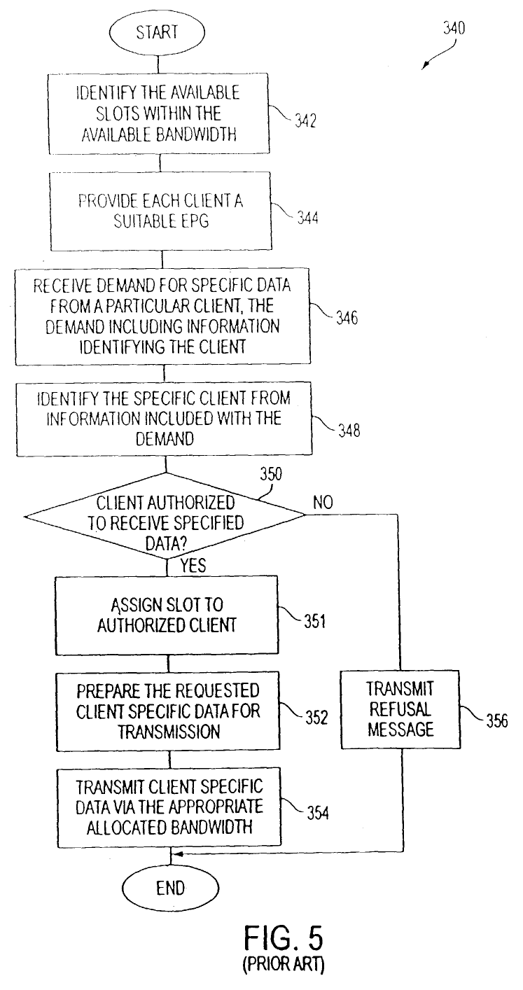

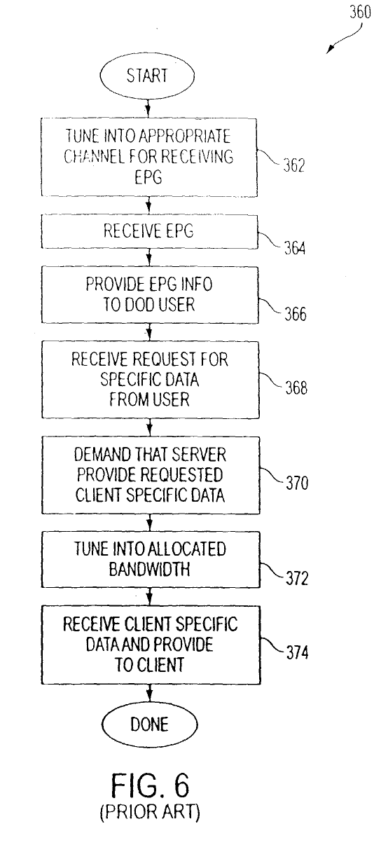

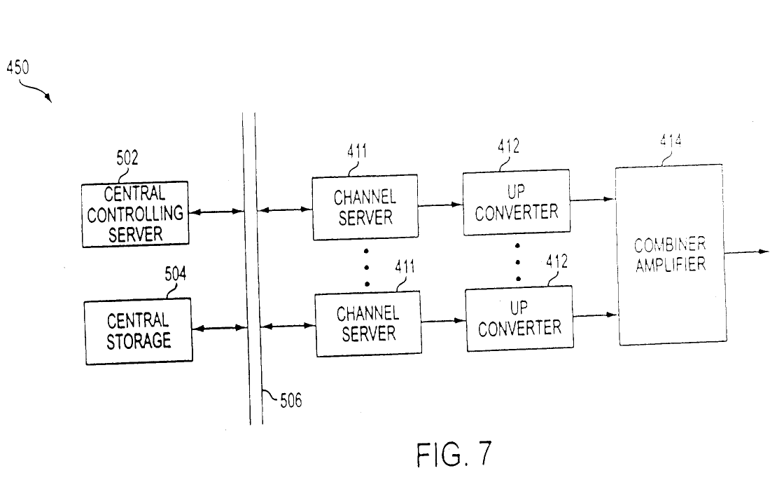

FIG. 7 illustrates the architecture for a digital broadcast server 450 in accordance with one embodiment of the present invention. The digital broadcast server 450 includes a plurality of channel servers 411, a plurality of up converters 412 each corresponding to a channel server 411, a combiner amplifier 414, a central controlling server 502, and a central storage 504, coupled as illustrated through a data bus 506. As will be described below, the central controlling server 502 controls off-line operation of the channel servers 411, as well as initiating real-time transmission once the channel servers 411 are ready. The central storage 504 typically stores data files in a digital format. However, any suitable mass persistent data storage device may be used.

In an exemplary embodiment, data files stored in the central storage 504 are accessible via a standard network interface (e.g., Ethernet connection) by any authorized computer, such as the central controlling server 502, connected to the network. The channel servers 411 provide data files that are retrieved from the central storage 504 in accordance with instructions from the central controlling server 502. The retrieval of digital data and the scheduling of transmission of the digital data is performed “off-line” to fully prepare each channel server 411 for real-time data transmission. Each channel server 411 informs the central controlling server 502 when ready to provide digital broadcast, at which point the central controlling server 502 can control the channel servers 411 to begin digital broadcast transmission.

In a preferred embodiment, the central controlling server 502 includes a graphics user interface (not shown) to enable a service provider to schedule data delivery by a drag-and-drop operation. Further, the central controlling server 502 authenticates and controls the channel servers 410 to start or stop according to delivery matrices. Systems and methods for providing uni-directional broadcast matrices are taught in Khoi Hoang's patent application entitled SYSTEMS AND METHODS FOR PROVIDING VIDEO ON DEMAND SERVICES FOR BROADCASTING SYSTEMS filed on May 31, 2000, bearing application Ser. No. 09/584,832, which is incorporated herein by reference.

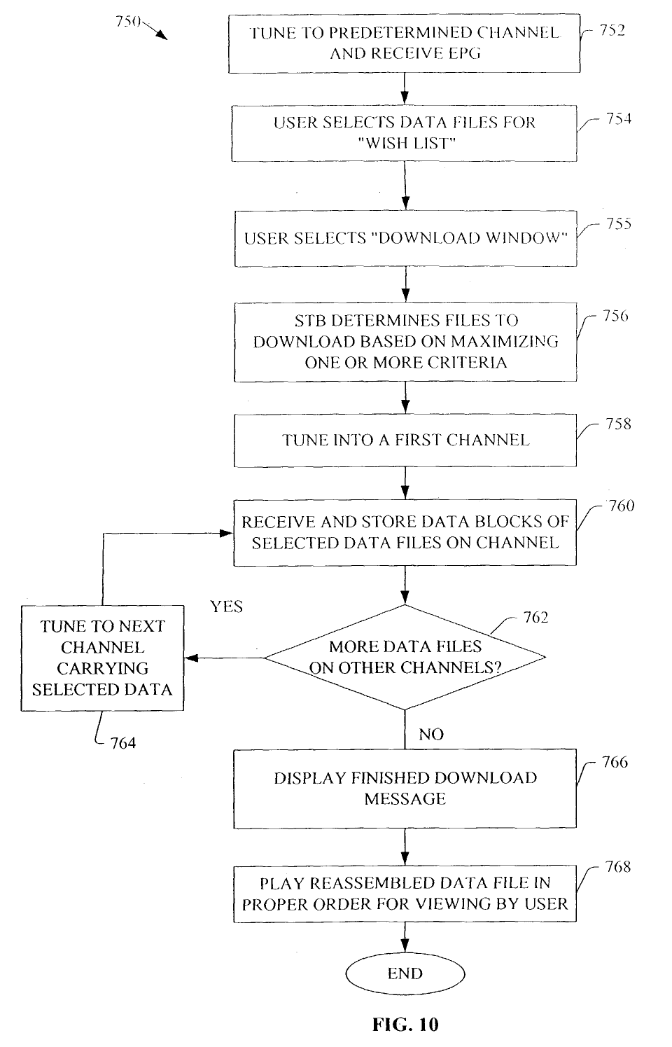

Each channel server 411 is assigned to a channel and is coupled to an up-converter 412. The output of each channel server 411 is a quadrature amplitude modulation (QAM) modulated intermediate frequency (IF) signal having a suitable frequency for the corresponding up-converter 412. The QAM-modulated IF signals are dependent upon adopted standards. The current adopted standard in the United States is the data-over-cable-systems-interface-specification (DOCSIS) standard, which requires an approximately 43.75 MHz IF frequency. A preferred channel server 411 is described below in more detail with reference to FIG. 10.

The up-converters 412 convert IF signals received from the channel servers 104 to radio frequency signals (RF signals). The RF signals, which include frequency and bandwidth, are dependent on a desired channel and adopted standards. For example, under the current standard in the United States for a cable television channel 80, the RF signal has a frequency of approximately 559.25 MHz and a bandwidth of approximately 6 MHz.

The outputs of the up-converters 412 are applied to the combiner/amplifier 414. The combiner/amplifier 414 amplifies, conditions and combines the received RF signals then outputs the signals out to a transmission medium.

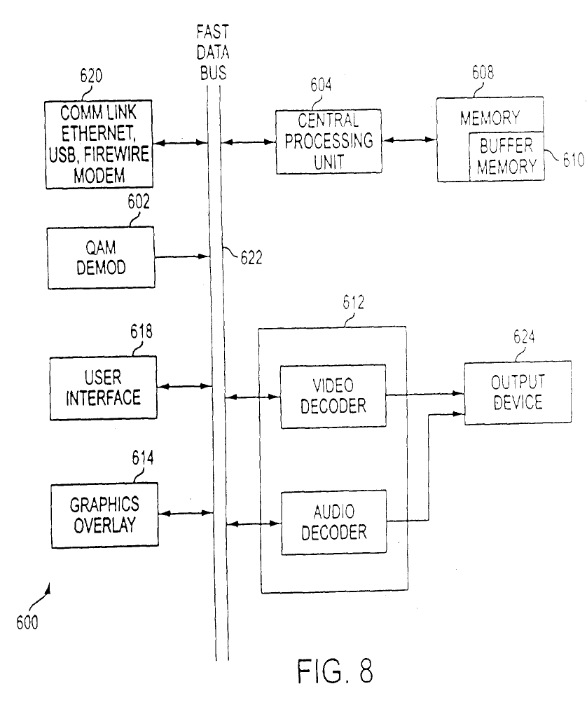

FIG. 8 illustrates an intelligent STB 600 in accordance with one embodiment of the invention. The STB 600 comprises a QAM demodulator 602, a CPU 604, a local memory 608, a buffer memory 610, a decoder 612 having video and audio decoding capabilities, a graphics overlay module 614, a user interface 618, a communications link 620, and a fast data bus 622 coupling these devices as illustrated. The CPU 602 controls overall operation of the intelligent STB 600 in order to select data in response to a client's request, decode selected data, decompress decoded data, re-assemble decoded data, store decoded data in the local memory 608 or the buffer memory 610, and deliver stored data to the decoder 612. In an exemplary embodiment, the local memory 608 comprises both non-volatile memory (e.g., a hard drive) and secure memory (e.g., a ROM chip), and the buffer memory 610 comprises volatile memory. A hardware identification code (not shown) is stored in a secure memory location of the local memory 608, this code is unique to the STB 600 and cannot be readily altered. An STB subscription level code is stored in a non-volatile memory location of the local memory 608, and is needed to access programs.

In one embodiment, the QAM demodulator 602 comprises transmitter and receiver modules and one or more of the following: privacy encryption/decryption module, forward error correction decoder/encoder, tuner control, downstream and upstream processors, CPU and memory interface circuits. The QAM demodulator 602 receives modulated IF signals, samples and demodulates the signals to restore data.

In an exemplary embodiment, when access is granted, the decoder 612 decodes each data block of a digital data file to transform the data into images displayable on an output screen. The decoder 612 supports commands from a subscribing client, such as play, stop, pause, step, rewind, forward, etc. The decoder 612 provides decoded data to a graphics overlay module 614, which transmits an output signal to an output device 624 for use by the client. The output device 624 may be any suitable device such as a television, computer, any appropriate display monitor, a VCR, or the like.

The graphics overlay module 614 enhances displayed graphics quality by, for example, providing alpha blending or picture-in-picture capabilities. In an exemplary embodiment, the graphics overlay module 614 can be used for graphics acceleration during game playing mode, for example, when the service provider provides games-on-demand services using the system in accordance with the invention.

The user interface 618 enables user control of the STB 600, and may be any suitable device such as a remote control device, a keyboard, a smartcard, etc. The communications link 620 provides an additional communications connection. This may be coupled to another computer, or may be used to implement bi-directional communication. The data bus 622 is preferably a commercially available “fast” data bus suitable for performing data communications in a real time manner as required by the present invention. Suitable examples are USB, firewire, etc. Although services are broadcast to all cable television subscribers, only the subscriber who has an STB 600 authorized to view a selected service will be able to decode and enjoy the selected service.

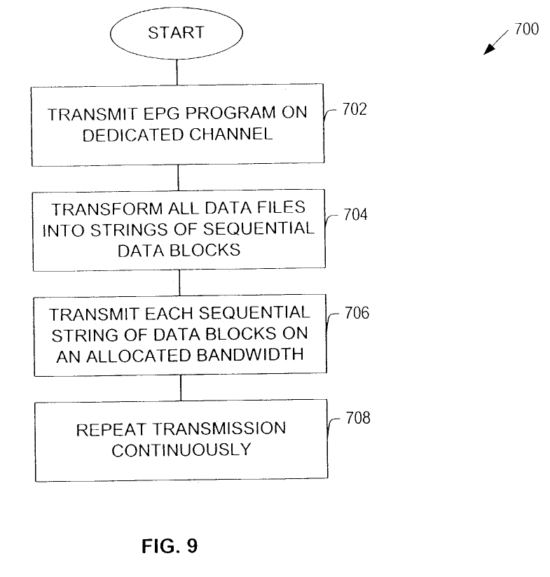

FIG. 9 illustrates a digital data file transmission process at 700 in accordance with one embodiment of the present invention. The process 700 starts at a step 702 at which the DOD broadcast server 450 (FIG. 7) transmits an electronic program guide (EPG) to each intelligent STB 600 (FIG. 8) on a dedicated program guide channel. The EPG lists all digital data files available from the digital broadcast server 450. Information contained on the EPG allows receiving STBs 600 to tune into a bandwidth associated with a selected data file.

In 704 all data files available on the broadcast server 450 are transformed into strings of sequential data blocks. In step 706 each string of data blocks is transmitted on an associated bandwidth allocated to that data file. Each sequence of data blocks is repeated continuously (708). In order to view a complete data file a user must possess each data block of the sequence associated with a selected data file.

FIG. 10 illustrates an intelligent STB process at 750 for selecting and downloading digital data files in accordance with one embodiment of the present invention. The process 750 starts at a step 752 at which the STB 600 (FIG. 8) tunes to a predetermined channel and bandwidth. At the predetermined bandwidth the STB receives an EPG program listing all available data files. In step 754 an STB user selects a number of digital data programs from the files listed on the EPG by pressing a button associated with each desired program, creating a “wish list” of programs to download. The wish list represents video programs or other data files a user would like to view. In step 755 the user selects a “download window.” Typically a download window will be some span of time that no one will need to watch broadcast television, but may still access stored videos.

In step 756 the STB calculates a download schedule. To calculate the download schedule appropriate for the “wish list” and download window selected by the user the STB must apply a scheduling algorithm. Generally the scheduling algorithm will be designed to maximize revenue to the cable provider, but may instead maximize the number of video files downloaded, etc. Generally different videos will cost a user a different amount. In accordance with an exemplary embodiment the scheduling algorithm will determine a maximum revenue of videos from the “wish list” that can be downloaded within the download window. Alternatively the scheduling algorithm may maximize the number of video programs that can be downloaded within the download window. This is described in more detail with reference to FIG. 11.

In step 758 the STB tunes into a first channel on which files scheduled for downloading are being transmitted. In step 760 the STB receives and stores the files from the channel in hard disk memory. In step 762, if more data files need to be downloaded the process continues to step 764. At 764 the STB tunes into the next channel carrying files for downloading.

In step 766 the STB displays an indicator that the download is complete and that the file is ready for viewing. The STB then waits for a command to play the downloaded file. Once the user presses a play button on the STB, the stored data blocks of the selected program are displayed to the user in a proper sequence for viewing in step 768.

In accordance with one embodiment of the present invention a client may assign a priority value to each program on the “wish list” indicating the clients desire for the particular title. In accordance with such an embodiment the scheduling algorithm would include this priority value in creating a download schedule. Titles may also be signed an increased weight by a broadcaster to promote viewing of the title, or any other legitimate purpose of the broadcast provider.

In accordance with another embodiment the scheduling algorithm will maximize a weight value of files to be downloaded. In such an embodiment each title will be assigned a weight value, a cost multiplier will be set by the broadcaster, the client will enter a priority value, and the broadcast provider will assign a priority multiplier. Thus each title of the “wish list” will have a total weight W determined by summing the title weight TW, the title cost TC times the cost multiplier CM, and the priority value PV times the priority multiplier PM.

W=TW+TC×CM+PV×PM Eq. 1

In such an embodiment the scheduling algorithm would maximize the total weight of all files that could be downloaded within the selected download window instead of simply maximizing the revenue that could be produced within the download window. Such an equation could also be used to offset variables in overhead such as royalties paid for selected programs. It may be desirable to discourage viewing of some offered services in favor of others in this manner. Specific equations for maximizing either revenue or weight are not within the purview of this application, but could be implemented to suit specific circumstances by one skilled in computer sciences.

FIG. 11 shows an exemplary embodiment of a download schedule at 800 in accordance with one embodiment of the present invention. In the present embodiment a user has selected a “wish list” containing titles 1-9. Titles 1-9 are being broadcast repetitively on broadcast channels 1 and 2, 802 and 804 respectively. Titles 1-9 may be video programs, audio programs, interactive computer software, etc. Titles 1-9 are shown as having varying download times, as would be typical of video programs offered by such a service.

The user has selected a download window 806 defining a time period that the set-top-box (STB) will not be in use. Download schedule 800 contains titles 1-7 and 9 because the download window 806 is insufficient to download all files on the wish list.

In the exemplary embodiment the STB is using a revenue maximizing algorithm with each title 1-3 costing $3 and each title 4-10 costing $2. Since title 2 and title 8 cannot both be downloaded within the selected download window, and since title 2 is more expensive than title 8, title 2 is selected for downloading and title 8 is discarded. Thus download revenue is maximized.

In accordance with one embodiment titles broadcast on channel 1 are downloaded first, then at time 810 the STB begins downloading files from broadcast channel 2. Generally the order in which the STB downloads files and from which channel is irrelevant since all files are broadcast repetitively. In accordance with an alternative embodiment, the STB can download from two or more channels simultaneously.

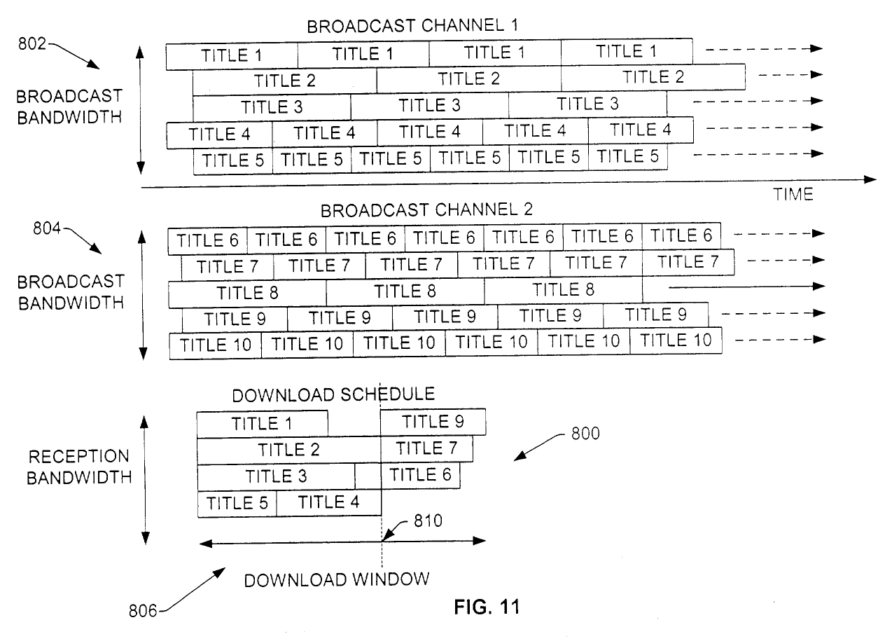

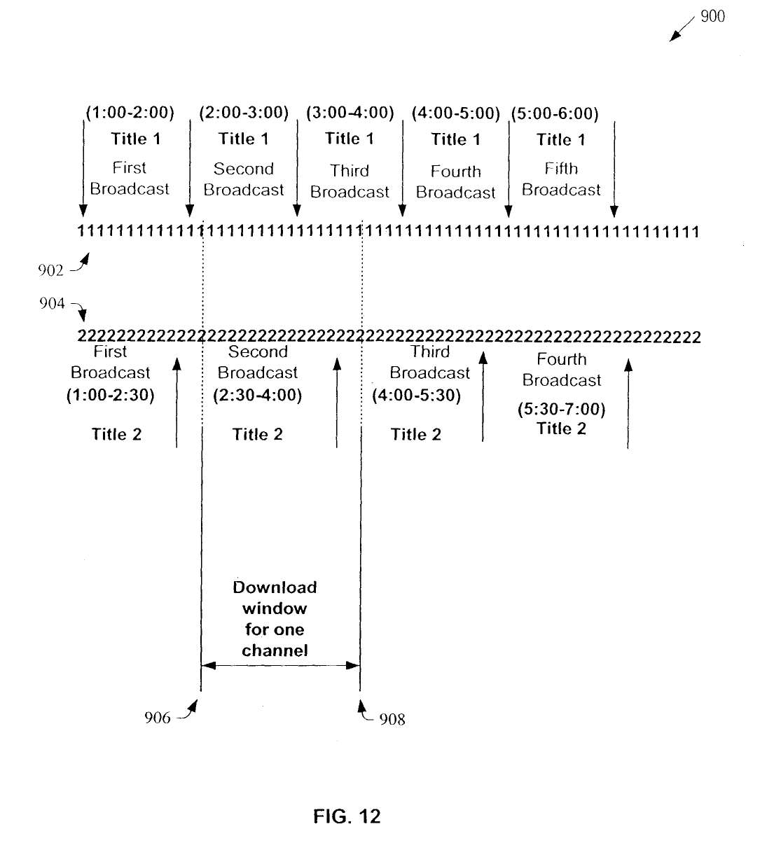

As shown in the download schedule 800, files need not be downloaded from the beginning of the file. Any file can be downloaded starting at any time on a single channel, though the total time required to download each file is dependent on the files transmission time. This is discussed in more detail with reference to FIG. 12.

In an exemplary embodiment 10 channels are allocated for non-DOD download service. Each channel would have a 36 Mb/s bandwidth for a typical Chinese 8 MHz system. In this exemplary embodiment each non-DOD data file will be allocated a 1 Mb/s bandwidth, with typical files having a 1.5 hour play time on average and being encoded using the MPEG-2 format at 2 Mb/s, though play times as long as 6 hours are not unheard of. This would allow an average of 36 movie titles to be transmitted over each channel for an average total of 360 downloaded movies available. Average download time would be approximately (1.5 hr×2 Mb/s)/1 Mb/s=3.0 hr, though any size file could be downloaded given enough time.

The following table illustrates exemplary scenarios for bit rate, bandwidth and necessary download time for movies averaging 1.5 hours:

TABLE 1

| Encoding | | | Download time |
|---|---|---|---|
| Rate (Mb/s) | Bandwidth (Mb/s) | Number of movies | (hrs) |
| 0.8 | 0.5 | 72 | 2.4 |
| 0.8 | 1 | 36 | 1.2 |
| 1 | 1 | 36 | 1.5 |
| 1 | 2 | 18 | 1.0 |
| 1.5 | 1 | 36 | 2.3 |
| 1.5 | 2 | 18 | 1.1 |
| 2 | 1 | 36 | 3.0 |
| 2 | 2 | 18 | 1.5 |

The encoded bit rate generally refers to the encoding rate of a movie file which would also correspond to the playback rate. The encoding rate varies among different protocols such as MPEG-2 with a lowest encoding rate of 2 Mb/s, MPEG-1 with an encoding rate or bit rate of as low as 0.25 Mb/s, or MPEG-4 with bit rates as low as several hundred Kb/s. Importantly, picture quality deteriorates as the bit rate increases. Moreover, picture quality deteriorates as the corresponding replay rate is reduced below a threshold.

The download rate or the transmission rate along with the bandwidth determine the download time necessary for a given file size. The system of the present invention is capable of supporting a transmission rate that may be independent of the encoding or playback rate. Furthermore, each sub-channel of the system may be used to transmit data at a different rate. Thus, the intelligent STB may download data from various subchannels within the same channel simultaneously, while the data is being broadcast at different rates. Typically the intelligent STB will be able to download 12-15 movies concurrently, each at 1 Mb/s.

The above example is only a generalized example for average 1.5 hour movies. The present invention is intended to be used with data files of any play length. Also a single channel may include video files of varying play lengths.

FIG. 12 shows an exemplary embodiment of two digital data files being transmitted on two independent bandwidths of a selected physical transmission channel at 800. A first digital data file 802 is transmitted repeatedly on a first bandwidth. Simultaneously a second digital data file 804 is repeatedly transmitted on a second bandwidth. Each data block of the first data file 802 is indicated by a numeral “1”. Similarly each data block of the second data file 804 is indicated by a numeral “2”.

As shown in FIG. 12, a first sequence of data blocks of first data file 902 is transmitted between 1:00 and 2:00, and is repeated every hour. Concurrently, a first sequence of data blocks of second data file 904 is transmitted between 1:00 and 2:30, and is repeated every one and one half hours. In an exemplary embodiment an intelligent STB 600 begins downloading the second data file 904 at a starting time 906. STB 600 will complete downloading second data file 904 at an ending time 908. Ending time 908 will be one and one half hours after starting time 906 regardless of when the starting time is. Similarly it would take one hour to download the first data file regardless of when the downloading was started.

As can be seen from FIG. 12, both first data file 902 and second data file 904 can be downloaded concurrently because they are being transmitted continuously on two separate bandwidths of a single channel.

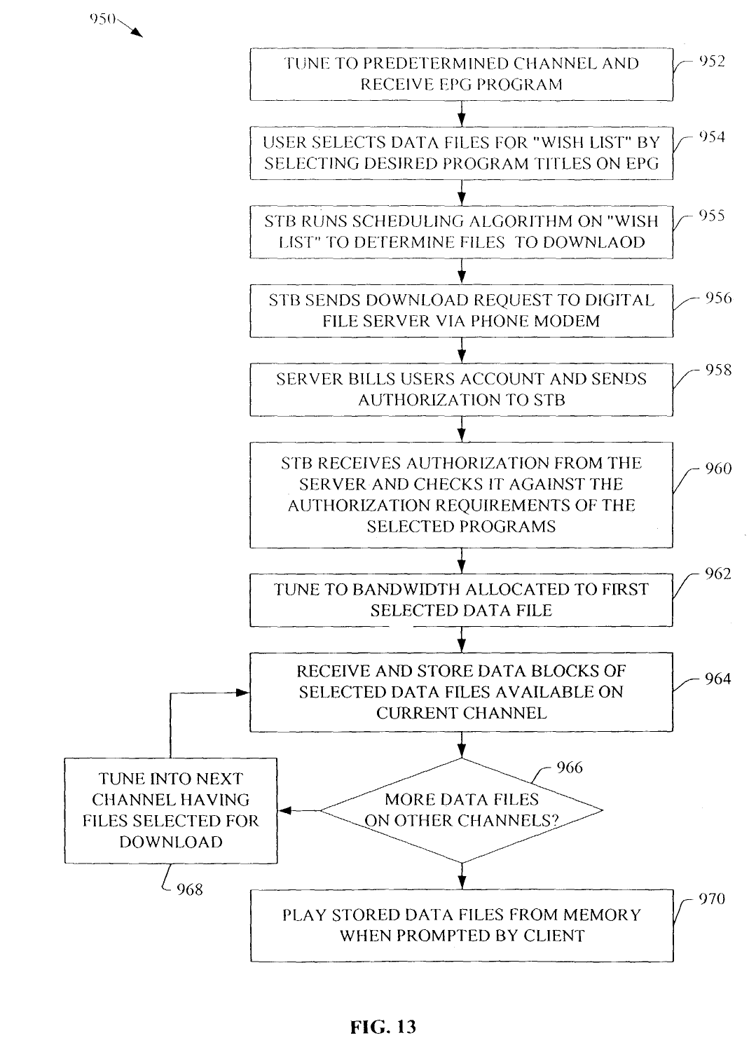

FIG. 13 shows an authorized file download process at 950 in accordance with one embodiment of the present invention including a bi-directional download authorization process. The process 950 starts at a step 952 at which the STB 600 (FIG. 8) tunes to a predetermined channel and bandwidth. At the predetermined bandwidth the STB receives an EPG program listing all available data files. In an exemplary embodiment 300 feature length movies are listed as available as downloadable titles. In step 954 an STB user selects a digital data programs from the files listed on the EPG for inclusion on a “wish list” of desired programs and selects a download window of time that the STB will not be needed for receiving other broadcast data. In step 955 the STB runs a scheduling algorithm with the programs on the “wish list” given the download window selected by the user. Typically this scheduling algorithm will maximize revenue for the broadcaster given the available download time.

In one embodiment a user will have an unlimited use plan with a set monthly fee. In such an embodiment the scheduling algorithm will simply download the maximum number of programs within the given download window.

In step 956 the STB sends a download request specifying the scheduled download programs to the server 450 (FIG. 7) via a phone modem connection. Alternatively any upstream communications link may be used to transmit this request.

In step 958 the server 450 (FIG. 7) bills the users account for an amount appropriate for viewing the selected programs and sends an authorization to the STB via a phone modem or other downstream means. This authorization may be in the form of a numeric code or some other message corresponding to each program to be downloaded that the STB may use to assure that the user is authorized view the programs. If a user is delinquent the server will deny the request.

In one embodiment the user may have a subscription level allowing unlimited access to certain programs. In such a case he would not be billed to view these programs.

In step 960 the STB receives this authorization indicating whether the user is able to view the selected programs. If the user is authorized to view the programs, in a step 962 the STB determines the bandwidth that a first selected digital data file is being transmitted on and tunes into that bandwidth. The specific bandwidth allocated to each selected data file is stored in the EPG program and accessed by the STB.

In step 964 the STB receives and stores the data blocks of the selected digital data files broadcast on the current channel. In step 966 the STB determines whether more data files are available on other channels. If other data files still need to be downloaded the STB will tune into the next channel broadcasting such files in step 968. Once all the selected files are downloaded the STB is ready to play programs from an internal hard disk when prompted by the client at step 970.

The foregoing examples illustrate certain exemplary embodiments of the invention from which other embodiments, variations, and modifications will be apparent to those skilled in the art. The invention should therefore not be limited to the particular embodiments discussed above, but rather is defined by the following claims.

What is claimed is:

1. A method of transmitting a plurality of non-data-on-demand (non-DOD) data files to a large number of customers comprising the acts of:
parsing at least one non-DOD data file into a sequence of data blocks, said sequence being composed of a first plurality of data blocks containing digital data;
repeatedly transmitting said sequence of data blocks in a non-client specific manner such that a user receiving said first plurality of data blocks may begin receiving said non-DOD data file at a selected start time, wherein the time required to download said data file is independent of said start time.

2. The method of claim 1 including transmitting an electronic program guide (EPG) to said plurality of users, wherein said user may select said selected data file using said electronic program guide.

3. The method of claim 1 wherein each non-DOD data file is allocated an associated bandwidth, wherein said data files are repeatedly transmitted on a corresponding allocated bandwidth.

4. The method of claim 2 wherein an icon corresponding to each data file is displayed via the EPG such that a user may select the data file by selecting the displayed icon.

5. The method of claim 1 wherein said at least one data file is a digital movie file including audio and visual data.

6. The method of claim 1 wherein at least one of said plurality of data files is a text file including textual information.

7. The method of claim 3 wherein a user may select a plurality of data files for a wish list and a download window, wherein files are selected from said wish list for download during said download window.

8. The method of claim 7 wherein a set-top-box (STB) receiver executes a scheduling algorithm to select said download files from said wish list.

9. The method of claim 8 wherein said scheduling algorithm maximizes revenue for a broadcast provider.

10. The method of claim 7 wherein said files selected for download are transmitted on a plurality of physical channels such that said STB must tune to each said channel to download files on each said channel.

11. The method of claim 10 wherein said STB is operative to download multiple data files simultaneously on each said physical channel.

12. The method of claim 9 wherein said scheduling algorithm selects files for downloading and an order in which the selected files are downloaded.

13. The method of claim 12 wherein data files selected for downloading are broadcast on multiple physical channels said scheduling algorithm also determines which channels the STB will tune to during a download process.

14. The method of claim 12 wherein data files selected for downloading are broadcast on multiple physical channels said scheduling algorithm also determines which channels the STB will tune to during a download process.

15. The method of claim 10 wherein said STB is operative to determine whether the client is authorized to download the selected data files.

16. The method of claim 10 wherein said STB is operative to generate billing information for the files selected for download.

17. The method of claim 17 wherein said STB is operative to provide said billing information to a service provider.

18. A method of downloading non-DOD data files broadcast periodically, using an intelligent STB comprising:
receiving a user input indicating at least one selected data file;
receiving at least a first part of the selected data file broadcast during a first time interval;
receiving at least a second part of the data file broadcast during a second time interval; and
combining said first part and said second part in order to reconstitute at least a portion of said selected data file.

19. The method of claim 18 further comprising:
retrieving an additional part of the data file broadcast during an additional time interval; and
rearranging all the parts to reconstitute the complete data file.

20. The method of claim 18, further comprising storing said first and second part of said data file in a memory location such that said data file may be displayed to a user.

21. The method of claim 18, wherein said data file has a predetermined beginning, further comprising storing said first part of said data file in a first memory location and said second part of said data file in a second memory location, and displaying said file from said stored first and second parts such that said data file may be viewed from said beginning of said data file.

22. The method of claim 18, further including the act of tuning to a transmission channel corresponding to said selected data file.

23. The method of claim 18, further including receiving an electronic program guide (EPG) on a predetermined bandwidth, said EPG enabling said user to select a desired data file for viewing.

24. The method of claim 23, wherein said EPG includes data indicating a bandwidth associated with said selected data file, and enables said STB to tune to said bandwidth associated with said selected data file.

25. The method of claim 18, further including determining an order in which said first and second parts of said data file are to be displayed to said user.

26. The method of claim 18, wherein said user input indicates a plurality of selected files for inclusion on a wish list and a time interval for downloading, wherein said STB is operative to execute a scheduling algorithm for determining files of said wish list to be downloaded.

27. The method of claim 26, wherein said scheduling algorithm is used to select files for download within said time interval in order to maximize revenue to a service provider.

28. An apparatus for retrieving non-DOD data files broadcast repetitively over at least a first time interval and a second time interval comprising:
means for receiving a file request from a user selecting at least one of the broadcast data files;
means for retrieving at least a first part of said data file broadcast during a first time interval;
means for retrieving at least a second part of said data file broadcast during the second time interval; and
means for combining said first part and said second part in order to reconstitute at least a portion of said selected data file.

29. The apparatus of claim 28 further including means for tuning to a transmission bandwidth corresponding with said selected data file.

30. The apparatus of claim 28 further including means for requesting an authorization for retrieval of the file requested.

31. The apparatus of claim 28 further comprising:
means for retrieving a third part of the data file broadcast during a third time interval; and
means for rearranging the first, second and third parts to reconstitutes the complete data file.

32. The apparatus of claim 28 further including means for receiving an electronic program guide (EPG).

33. The apparatus of claim 32, wherein said EPG enables a user to select a desired data file.

34. The apparatus of claim 32, wherein said EPG contains information corresponding to at least one non-DOD data file, said information enabling a set-top-box (STB) to tune into a transmission bandwidth corresponding to said data file.

35. The apparatus of claim 33 wherein said STB automatically determines a download time and a play time from data transmitted with the EPG corresponding to the file selection by the user and automatically displays at least a portion of said file after a waiting period, said waiting period duration being responsive to said download time and said play time.

36. An apparatus for retrieving non-DOD data files broadcast repetitively over at least a first time interval and a second time interval comprising:
an input device for receiving a file request from a user selecting at least one of the broadcast data files;
a first communications port for retrieving at least a first part of said data file broadcast during a first time interval, said first communications port further operative for retrieving at least a second part of said data file broadcast during the second time interval; and
a processor for combining said first part and said second part in order to reconstitute at least a portion of said selected data file.

37. The apparatus of claim 36 further including a tuning device for tuning to a transmission bandwidth corresponding with said selected data file.

38. The apparatus of claim 36 further including a second communications port for requesting an authorization for retrieval of the file requested.

39. The apparatus of claim 36, wherein said first communications port is further
operative for retrieving a third part of the data file broadcast during a third time interval; and
said processor is further operative for rearranging the first, second and third parts to reconstitutes the complete data file.

40. The apparatus of claim 36, wherein said first communications port is further operative for receiving an electronic program guide (EPG).

41. The apparatus of claim 40, wherein said EPG enables a user to select a desired data file.

42. The apparatus of claim 41, wherein said EPG contains information corresponding to at least one non-DOD data file, said information enabling a set-top-box (STB) to tune into a transmission bandwidth corresponding to said data file.

43. The apparatus of claim 38, wherein said second communications port is capable of bi-directional communication with a broadcast server system.

44. A broadcast server apparatus for transmitting a large number of client generic non-DOD data files to a large number of recipients over a wide area network comprising;
a storage server for storing data files;
a channel server for retrieving selected data files from said storage server;
a transmitter for repeatedly transmitting a first data file over an allocated bandwidth such that a receiver may reproduce said first data file by receiving an end portion of a first transmission of said first data file and a beginning portion of a second transmission of said first data file, and combining said beginning portion and said end portion to create a complete data file.

45. A method of downloading non-DOD data files broadcast in a uni-directional manner, using an intelligent STB comprising:
receiving a user input indicating a plurality of desired data files;
determining a download window for receiving data files;
selecting data files from said desired data files; and
receiving said selected data files within said download window.

46. The method of claim 45, wherein said desired data files comprise a wish list, and wherein selecting data files from said wish list includes executing a maximization algorithm.

47. The method of claim 46, wherein said maximization algorithm is operative to determine a maximum revenue that may be produced within said download window.

48. The method of claim 46, wherein each said desired data file has a size, and wherein said maximization algorithm is responsive to said download window and the size of each said desired data file.

49. The method of claim 46, wherein said maximization algorithm determines said selected data files for download.

50. The method of claim 49, wherein said selected files for download are broadcast on a plurality of channels said maximization algorithm determines which channels said STB is tuned to during downloading such that said STB can download selected files from each of said plurality of channels.
